(19) United States
(12) Patent Application Publication
(10) Pub. No.: US 2017/0076700 A1
(43) Pub. Date: Mar. 16, 2017

(54) IMAGE PROCESSING DEVICE AND IMAGE PROCESSING METHOD

(71) Applicant: SAMSUNG DISPLAY CO., LTD., Yongin-si (KR)

(72) Inventors: Hyun Seuk YOO, Yongin-si (KR); Kamal HASSAN, Yongin-si (KR); Yong Seok CHOI, Yongin-si (KR)

(21) Appl. No.: 15/156,818

(22) Filed: May 17, 2016

(30) Foreign Application Priority Data
Sep. 10, 2015 (KR) 10-2015-0128623

(51) Int. Cl. G09G 5/39

(52) U.S. Cl. CPC G09G 5/39; G09G 2320/0613; G09G 2350/00; G09G 2360/12

(57) ABSTRACT

An image processing device includes a determiner, a selector, and a compressor. The determiner determines the type of an image. The selector determines a compression ratio of the image according to the image type. The compressor compresses the image based on the compression ratio.

### CROSS-REFERENCE TO RELATED APPLICATION

Korean Patent Application No. 10-2015-0128623, filed on Sep. 10, 2015, and entitled “Image Processing Device and Image Processing Method,” is incorporated by reference herein in its entirety.

### BACKGROUND

1. Field

One or more embodiments described herein relate to an image processing device and an image processing method.

2. Description of the Related Art

Memory bandwidth requirements increase as display resolution increases. When the display is incorporated into a smart phone or other portable device, large amounts of image data are transferred from an application processor to a display driver. This increases in power consumption.

### SUMMARY

In accordance with one or more embodiments, an image processing device includes a determiner to determine a type of an image; a selector to determine a compression ratio based on the image type; and a compressor to compress the image based on the compression ratio. The image type may be a motion picture or a still image, and the determiner may analyze the image to determine whether the image is a motion picture or a still image.

The selector may determine a first compression ratio as a compression ratio of the image when the image type is a motion picture and to determine a second compression ratio different from the first compression ratio as a compression ratio of the image when the image is a still image. The first compression ratio may be greater than the second compression ratio.

The selector may generate a compression ratio flag indicating the determined compression ratio and is to transmit the compression ratio flag to a display device. The compression ratio flag may be transmitted to a decompressor of a display driver inside the display device.

The determiner may calculate a total sum of pixel data in the image, and compare the calculated result with a total sum of pixel data in a previous image, determines the image as a motion picture if a difference between the total sum of the pixel data in the image and the total sum of the pixel data in the previous image exceeds a predetermined first threshold value, and determine the image as a still image when a difference between the total sum of the pixel data in the image and the total sum of the pixel data in the previous image is less than the first threshold value.

The determiner may count a number of pixels in which data values are different by comparing the pixel data of the pixels in the image with the pixel data of the corresponding pixels in a previous image, determine the image as a motion picture when the number of pixels where the data values are different exceeds a predetermined second threshold value, and determine the image as a still image when the number of pixels where the data values are different is less than the second threshold value.

The determiner may sample one or more pixels in the image, calculate a total sum of pixel data of the one or more sampled pixels, compare the total sum of the pixel data of the one or more sampled pixels with a total sum of pixel data of one or more corresponding pixels in a previous image, determine the image as a motion picture when a difference between the total sum of the pixel data of the one or more sampled pixels and the total sum of the pixel data of the one or more corresponding pixels in the previous image exceeds a predetermined third threshold value, and determines the image as a still image when a difference between the total sum of the pixel data of the one or more sampled pixels and the total sum of the pixel data of the one or more corresponding pixels in the previous image is less than the third threshold value.

The determiner may count a number of vertical synchronization signals VSYNC generated for a unit time, determine the image as a motion picture when the counted number exceeds a predetermined fourth threshold value, and determine the image as a still image when the counted number is less than the fourth threshold value.

In accordance with one or more other embodiments, an image processing device includes an application processor to determine a compression ratio of an image according to a type of the image and to compress the image based on the compression ratio; and a display device to receive the compressed image and decompress the compressed image based on the compression ratio.

The application processor may include a determiner to determine a type of an image; a selector to determine a compression ratio of the image according to the image type; and a compressor to compress the image based on the compression ratio, wherein selector is to determine a first compression ratio as a compression ratio of the image when the image type is a motion picture and is to determine a second compression ratio different from the first compression ratio as a compression ratio of the image when the image is a still image. The display device may include a frame memory to store the compressed image; and a decompressor to decompress the compressed image stored in the frame memory based on the compression ratio determined by the selector. The display device may include a display panel to display the decompressed image.

In accordance with one or more other embodiments, an image processing method includes receiving an image; determining a type of the image; determining a compression ratio based on the image type; and compressing the image based on the compression ratio. The image type may be one of a motion picture or a still image; and determining the type of image may include comparing the image with a previous image.

Determining the compression ratio may include determining the compression ratio as a first compression ratio when the image type is a motion picture and determining the compression ratio as a second compression ratio lower than the first compression ratio when the image type is a still image. Determining the image type may include calculating a total sum of pixel data in the image; comparing a total sum of the pixel data in a previous image with the total sum of the pixel data in the image; and determining the image as a motion picture or a still image based on a result of the comparison.

Determining the image type may include determining the image type as a motion picture when a difference between the total sum of the pixel data in the image and the total sum of the pixel data in the previous image exceeds a predetermined first threshold value, and determining the image type as a still image when a difference between the total sum of the pixel data in the image and the total sum of the pixel data in the previous image is less than the first threshold value.

### BRIEF DESCRIPTION OF THE DRAWINGS

Features will become apparent to those of skill in the art by describing in detail exemplary embodiments with reference to the attached drawings in which:

FIG. 1 illustrates an embodiment of an image processing device;

FIG. 2 illustrates a more detailed embodiment of an image processing device;

FIG. 3 illustrates another embodiment of an image processing device;

FIG. 4 illustrates a more detailed embodiment of an image processing device;

FIG. 5 illustrates an embodiment of a method for compressing an image; and

FIG. 6 illustrates an embodiment of a method for displaying an image.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments described herein may be combined to form additional embodiments.

In the drawings, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It is to be understood that when one component is referred to as being “connected” or “coupled” to another component, it may be connected or coupled directly to another component or may be connected or coupled to another component with the other component intervening therebetween. On the other hand, it is to be understood that when one component is referred to as being “directly connected” or “directly coupled” to another component, it may be connected or coupled to another component without any other component intervening therebetween. Other expressions describing the relationship between the components, that is, “between” and “directly between” or “adjacent to” and “directly adjacent to” should also be similarly interpreted.

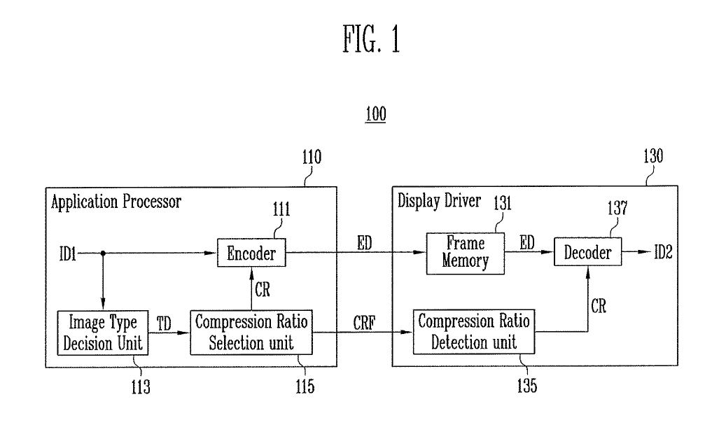

FIG. 1 illustrates an embodiment of an image processing device 100 which includes an application processor 110 and a display driver 130. The application processor 110 may include an encoder 111, an image type decision unit 113, and a compression ratio selection unit 115. The display driver 130 may include a frame memory 131, a decoder 137, and a compression ratio detection unit 135.

Image data ID1 received by the application processor 110 may be transmitted to the image type decision unit 113 and the encoder 111. In FIG. 1, the encoder 111 may perform various operations associated with encoding the image data. In the current exemplary embodiment, the encoder 111 may perform an operation for compressing the input image data ID1 at a predetermined compression ratio.

The image type decision unit 113 may receive the image data ID1, determine the type of image data ID1 (e.g., still image or motion picture), and transmit the determination result TD to the compression ratio selection unit 115.

The image type decision unit 113 may determine the type of the image data ID1 in various ways. In one exemplary embodiment, the image type decision unit 113 may calculate a total sum of all pixel data in the image data ID1 and a total sum of all pixel data in image data one frame before the image data ID1 and compare the two values.

When the difference between the total sum of the entire pixel data in the image data ID1 and the total sum of the entire pixel data in the image data one fame before exceeds a predetermined specific threshold value, the image type decision unit 113 may determine the type of the corresponding image data as a motion picture type, since data of the two frames are different.

When the difference between the total sum of the entire pixel data in the image data ID1 and the total sum of the entire pixel data in the image data one frame before is equal to 0 or less than a predetermined specific threshold value (e.g., a first threshold value), the image type decision unit 113 may determine the type of the corresponding image data as a still image type, since data between the two frames are substantially the same.

In another exemplary embodiment, the image type decision unit 113 may count the number of pixels in which data values are different by comparing the pixel data of the pixels in the input image ID1 with the pixel data of the pixels in the image one frame before the input image ID1. The image type decision unit 113 may determine the image as a motion picture when the number of pixels in which the data values are different exceeds a predetermined specific threshold value (e.g., a second threshold value), and may determine the image as a still image when the number of pixels in which the data values are different is less than the second threshold value.

For example, when the input image ID1 has a size of m×n, the image type decision unit 113 may compare first pixel data of the input image ID1 with first pixel data of the previous frame image. The image type decision unit 113 may increment the count value by 1 when the two pixel data values are different and maintain the count value when the two pixel data values are the same.

Subsequently, the image type decision unit 113 may compare the second pixel data of the input image ID1 with the second pixel data of the previous frame image. The image type decision unit 113 may then increment the count value by 1 when the two pixel data values are different and maintain the count value when the two pixel data values are the same.

The image type decision unit 113 may repeatedly perform the aforementioned operations until the last pixel of the input image ID1, namely an (m×n)-th pixel, is finished.

After the count operation is finished, the image type decision unit 113 may compare the counted value with the predetermined second threshold value. When the counted value is greater than the second threshold value (e.g., when there is a relatively large number of pixels in which data is varied), the image type decision unit 113 may determine the input image ID1 as a motion picture. When the counted value is less than the second threshold value (e.g., when there is a relatively small number of pixels in which data is varied), the image type decision unit 113 may determine the input image ID1 as a still image.

In another exemplary embodiment, the image type decision unit 113 may determine whether the image data is a motion picture or a still image based on some of the pixel data sampled from the pixel data in the image data ID1. For example, when a total of p pixel data is in the image data ID1, the image type decision unit 113 may sample q pixel data, where q is a natural number greater than 0 and less than p.

The image type decision unit 113 may calculate a total sum of q pixel data values sampled in the image data ID1, and may calculate a total sum of q pixel data values in the previous frame image of the image data ID1. The q pixels in the previous frame image may respectively correspond to the q pixels sampled in the image data ID. For example, the q pixels in the previous frame image have the same positions (e.g., x and y coordinates) in the frame as the q pixels sampled in the image data ID1.

The image type decision unit 113 may calculate a difference value by comparing the total sum of the pixel data of the q pixels sampled in the image data ID1 and the total sum of the pixel data of the corresponding q pixels in the previous frame image. When the difference value exceeds a predetermined specific threshold value (e.g., a third threshold value), the image type decision unit 113 may determine the image as a motion picture and may determine the image as a still image when the difference value is less than the third threshold value.

In operation, a vertical synchronization signal VSYNC may be frequently generated when displaying a motion picture. A vertical synchronization signal VSYNC may be more intermittently generated when a still image is displayed and thus the image data may not changed. Accordingly, in another exemplary embodiment, the image type decision unit 113 may determine the type of the image data ID1 based on the frequency of the vertical synchronization signal VSYNC generated in application processor 110.

For example, the image type decision unit 113 may receive the vertical synchronization signal VSYNC, count the number of vertical synchronization signals VSYNC generated for a unit time, and determine the type of the input image as a motion picture when the counted value exceeds a predetermined specific threshold value (e.g., a fourth threshold value). The image type decision unit 113 may determine the type of the input image as a still image when the counted value is less than the specific threshold value (e.g., the fourth threshold value). In another embodiment, a different method may be used to determine the image type.

The image type decision unit 113 may determine the image type based on the image data ID1 and may transmit the determination result TD to the compression ratio selection unit 115. The compression ratio selection unit 115 may determine the compression ratio of the image data ID1 based on the determination result TD.

In one embodiment, the compression ratio selection unit 115 may determine the compression ratio of the corresponding image data ID1 as a relatively high compression ratio (e.g., a first compression ratio) when the image data ID1 is a motion picture, and may determine a compression ratio of the corresponding image data ID1 as a relatively low compression ratio (e.g., a second compression ratio) when the image data ID1 is a still image.

The first and second compression ratios may be determined in various ways. For example, the first and second compression ratios may be determined by a bandwidth of the channel which corresponds to a transmission path of the compressed image data ED between the application processor 110 and the display driver 130.

Alternatively, depending on the storage capacity of the frame memory 131 in the display driver 130, the first compression ratio and the second compression ratio may be predetermined. In one embodiment, the first compression ratio may be greater than the second compression ratio. Thus, for example, a relatively high compression ratio may be applied for a motion picture and a relatively low compression ratio may be applied for a still image.

The compression ratio selection unit 115 may transmit the determined compression ratio CR to the encoder 111. The encoder 111 may perform various encoding-related operations for the input image data ID1. In one embodiment, the encoder 111 may perform an operation for compressing the input image data ID1 at a predetermined compression ratio, e.g., the encoder 111 may operate as a compressor.

The encoder 111 may compress the image data ID1 based on the compression ratio CR from the compression ratio selection unit 115. In one exemplary embodiment, the encoder 111 may include a compressor that supports multiple compression ratios. For example, when the image data ID1 is a motion picture, the compression ratio selection unit 115 may determine a compression ratio CR of 1:4 and may transmit the compression ratio to the encoder 111. In this case, the encoder 111 may compress the image data ID1 to one fourth the original size and may generate the compressed image data ED.

When the image data ID1 is a still image, the compression ratio selection unit 115 may determine the compression ratio CR of 1:3 and may transmit the ratio CR to the encoder 111. The encoder 111 may then compress the image data ID1 to one third the original size and may generate compressed image data ED. The compressed image data ED may be transmitted to the display driver 130.

When the compression ratio CR is determined, the compression ratio selection unit 115 may generate a compression ratio flag CRF indicating the determined compression ratio and may transmit the flat CRF to the display driver 130. The display driver 130 decompresses the image data based on the compression ratio flag CRF.

The display driver 130 may include the frame memory 131, the decoder 137, and the compression ratio detection unit 135. The frame memory 131 receives and stores the compressed image data ED from the application processor 110. The compression ratio detection unit 135 receives the compression ratio flag CRF from the compression ratio selection unit 115 in the application processor 110. The compression ratio detection unit 135 transmits the compression ratio CR of the compressed image data ED to the decoder 137 based on the received compression ratio flag CRF.

The decoder 137 may perform various operations for decoding data encoded by the encoder 111. In one embodiment, the decoder 137 may perform decompress the compressed image data ED. Thus, the decoder 137 may operate as a decompressor. The decoder 137 may decompress the compressed image data ED based on the compression ratio CR from the compression ratio detection unit 135. Decompressed image data ID2 may be generated as the decoder 137 performs the decompressing operation.

The decompressed image data ID2 may be the same as the image data ID1 received by the application processor 110. In this case, the encoder 111 may perform lossless compression to generate the compressed image data ED. Alternatively, the decompressed image data ID2 may be different from the image data ID1 received by the application processor 110. In this case, the encoder 111 may perform lossy compression to generate the compressed image data ED.

In one embodiment, a relatively high compression ratio may be applied for a motion picture and a relatively low compression ratio may be applied for a still image, in order to thereby compress the image ID1. When the input image is a motion picture and the encoder 111 performs lossy compression, compression loss is present but the image displayed on a screen constantly changes. Thus, it may be difficult to recognize image loss compared to a still image, even if a relatively high compression ratio is applied to compress the image. Accordingly, when a high compression ratio is used, less transmission bandwidth may be used when the compressed image data ED is transmitted from the application processor 110 to the display driver 130. In addition, power loss of the display driver 130 may be reduced compared with a case in which a motion picture is compressed and displayed at a low compression ratio.

Since the image displayed on the screen does not change when the input image is a still image, it is easy to recognize compression loss when the image is compressed at a high compression ratio. In one embodiment, image quality degradation recognized by a user may be minimized since the image is compressed at a low compression ratio for a still image.

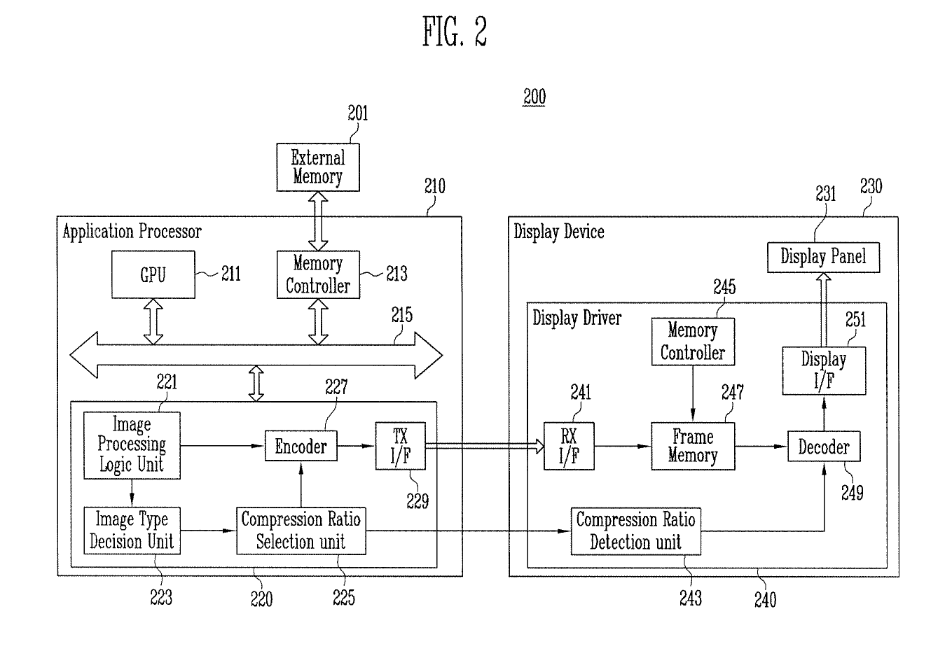

FIG. 2 illustrates another embodiment of an image processing device 200, which may be a more detailed embodiment of the image processing device in FIG. 1. Referring to FIG. 2, the image processing device 200 includes an external memory 201, an application processor 210, a display device 230. In addition, the display device 230 may include a display panel 231 and a display driver 240. The image processing device 200 in FIG. 2 may be implemented, for example, as a television, a digital TV, an Internet protocol television, a computer, or a portable device.

The portable device may be a device including the display panel 231 and may be implemented as a handheld device, e.g., a laptop computer, a mobile phone, a smart phone, a tablet PC, a personal digital assistant, an enterprise digital assistant, a digital still camera, a digital video camera, a portable multimedia player, a personal navigation device or portable navigation device, a handheld game console, or an e-book.

The external memory 201 may be implemented as a volatile memory such as dynamic random access memory (DRAM or a non-volatile memory such as flash memory, resistive memory, or phase change random access memory (PRAM).

The application processor 210 may control operation of the display device 230. For example, the application processor 210 may control operation of the display driver 240, and may transmit data (e.g., image data, 3D image data, stereoscopic 3D image data) to the display driver 240. In one exemplary embodiment, the application processor 210 may transmit compressed image to the display driver 240. According to the current exemplary embodiment, the application processor 210 transmits the compressed image to the display driver 210 by applying different compression ratios depending on whether the input image is a still image or a motion picture. In addition, the display driver 240 may control operation of the display panel 231.

The application processor 210 may include a graphics processing unit (GPU) 211, a memory controller 213, and a display controller 220 that can communicate with each other via a bus 215. The GPU 211 controls operation of the application processor 210. In one embodiment, the GPU 211 may control the memory controller 213 and the display controller 220.

The memory controller 213 may transmit image data output from the external memory 201 (e.g., video image data or still image data) to the display controller 220 via the bus 215.

The display controller 220 may transmit compressed image data (or encoded image data) to the display driver 240 via a communication channel. For example, the display controller 220 may transmit to the display driver 240 at least one control signal (e.g., a clock signal, a synchronization signal, or a signal associated with the synchronization for the display driver 240) to process the image data, as well as the image data. In one exemplary embodiment, the display controller 220 may compress the input image data at different compression ratios according to the image type and may transmit it to the display driver 240.

In one exemplary embodiment, the display controller 220 may include an image processing logic unit 221, an encoder 227, an image type decision unit 223, a compression ratio selection unit 225, and a transmit (Tx) interface 229.

The image processing logic unit 221 may be controlled by GPU 211 to process the image data transmitted from the memory controller 213 and may output the processed image data to the encoder 227. In addition, the image type decision unit 223 may receive the image data from the image processing logic unit 221 to determine whether the corresponding image data is a still image or a motion picture. The image type decision unit 223 may transmit the determination result to the compression ratio selection unit 225.

The image type decision unit 223 may receive the image data to determine the type of image data, e.g., still image or motion picture. The image type decision unit 223 may transmit the determination result to the compression ratio selection unit 225. The image type decision unit 223 may determine the type of the image data in various ways, e.g., using the same methods as described with reference to FIG. 1.

The compression ratio selection unit 225 may determine the compression ratio of the image data based on the determination result of the image type decision unit 223. In one embodiment, the compression ratio selection unit 225 may determine the compression ratio of the image data as a relatively high compression ratio (e.g., a first compression ratio) when the image data is a motion picture and may determine the compression ratio of the image data as a relatively low compression ratio (e.g., a second compression ratio) when the image data is a still image.

The image processing device 200 may apply a relatively high compression ratio for a motion picture and a relatively low compression ratio for a still image, to thereby compress the image. When the input image is a motion picture and the encoder 227 performs lossy compression, compression loss is present but the image displayed on a screen constantly changes. Thus, it may be difficult to recognize image loss as compared to a still image, even when a relatively high compression ratio is applied to compress the image. Accordingly, when a high compression ratio is used, less transmission bandwidth is used when the compressed image data is transmitted from the application processor 210 to the display driver 240. In addition, power loss of the display driver 240 may be reduced compared with a case in which a motion picture is compressed and displayed at a low compression ratio.

Since the image displayed on the screen does not change when the input image is a still image, it is easy to recognize compression loss when the image is compressed at a high compression ratio. In the image processing device 100 according to one embodiment, image quality degradation recognized by a user may be reduced or minimized since the image is compressed at a low compression ratio for a still image.

The encoder 227 may compress image data DATA output from the image processing logic unit 221 and may output compressed image data. For example, the encoder 227 may be implemented as a compressor. The encoder 227 may be controlled by the image processing logic unit 221.

The Tx interface 229 may be implemented as a CPU interface, RGB interface, or serial interface. The Tx interface 229 may be implemented, for example, as a mobile display digital interface (MDDI), a mobile industry processor interface (MIPI), a serial peripheral interface (SPI), an inter IC (I2C) interface, an interface supporting DisplayPort (DP), an interface supporting embedded DisplayPort (eDP), or a high-definition multimedia interface (HDMI).

The display driver 240 may receive the image data compressed by the application processor 210 to store it in the frame memory 247, decompress the image data outputted from the frame memory 247, and transmit decompressed image data to the display panel 231.

The display driver 240 includes a receive (Rx) interface 241, a decoder 249, a memory controller 245, a frame memory 247, a compression ratio detection unit 243, and a display interface 251. The Rx interface 241 may be implemented as the same as the transmit (Tx) interface 229.

The memory controller 245 may control one or more access operations for the frame memory 247 (e.g., a write operation for writing the image data to the frame memory 247 and/or a read operation for reading the image data from the frame memory 247) in accordance with a control signal. The frame memory 247 may be controlled by the memory controller 245 to store or output the compressed image data from the application processor 210.

The compression ratio detection unit 243 receives a compression ratio flag from the compression ratio selection unit 225 in the application processor 210. In addition, the compression ratio detection unit 243 transmits a compression ratio of the image data, which is compressed based on the received compression ratio flag, to the decoder 249.

The decoder 249 may receive the compression ratio of the image data from the compression ratio detection unit 243. The decoder 249 may also decompress the compressed image data output from the frame memory 247 based on the compression ratio. The decoder 249 may output decompressed image data. In this case, the decoder may be implemented as a decompressor.

The display interface 251 may process the image data output from the decoder 249 and may transmit the processed image data to the display panel 231. For example, the display interface 251 may convert the image data (e.g., a digital signal) to an image signal (e.g., an analog signal) and transmit the image signal to the display panel 231.

The display panel 231 may display an image corresponding to the image signal output from the display driver 240. The display panel 231 may be implemented, for example, as a thin film transistor-LCD (FTF-LCD), a light emitting diode (LED) display, an organic LED (OLED) display, or an active-matrix OLED (AMOLED) display.

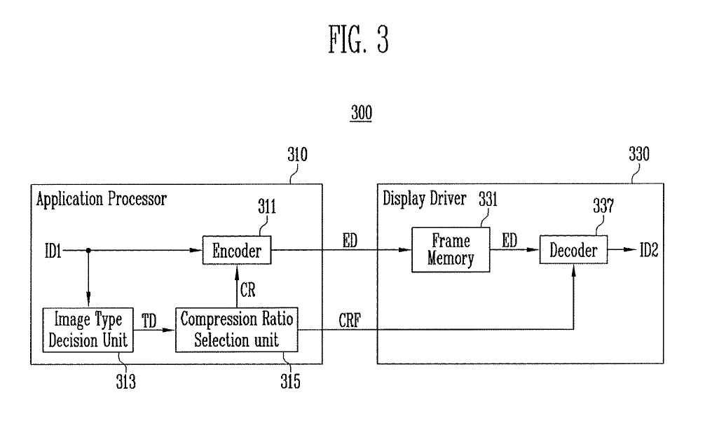

FIG. 3 illustrates another embodiment of an image processing device 300 which includes an application processor 310 and a display driver 330. In one exemplary embodiment, the application processor 310 may include an encoder 311, an image type decision unit 313, and a compression ratio selection unit 315. In addition, the display driver 330 may include a frame memory 331 and a decoder 337.

Image data ID1 received by the application processor 310 may be transmitted to the image type decision unit 313 and the encoder 311. In FIG. 3, the encoder 311 may perform various operations associated with encoding of the image data. For example, the encoder 311 may compress the input image data ID1 based on a predetermined compression ratio.

The image type decision unit 313 may receive the image data ID1 to determine the type of the image data ID1, e.g., a still image or a motion picture. The image type decision unit 313 may transmit the determination result TD to the compression ratio selection unit 315.

The compression ratio selection unit 315 may determine the compression ratio of the image data ID1 based on the determination result TD. In one embodiment, the compression ratio selection unit 315 may determine the compression ratio of the corresponding image data ID1 as a relatively high compression ratio (e.g., a first compression ratio) when the image data ID1 is a motion picture and may determine a compression ratio of the corresponding image data ID1 as a relatively low compression ratio (e.g., a second compression ratio) when the image data ID1 is a still image. In one embodiment, a relatively high compression ratio is applied for a motion picture and a relatively low compression ratio may be applied for a still image.

The compression ratio selection unit 315 may transmit the determined compression ratio CR to the encoder 311, and the encoder 311 may compress the input image data ID1 at a predetermined compression ratio. In this case, the encoder 311 may operate as a compressor.

The encoder 311 may compress the image data ID1 based on the compression ratio CR from the compression ratio selection unit 315. In one exemplary embodiment, the encoder 311 may include a compressor that supports multiple compression ratios.

When the compression ratio CR is determined, the compression ratio selection unit 315 may generate a compression ratio flag CRF indicating the determined compression ratio and may transmit the compression ratio flag CRF to the display driver 330. The display driver 330 decompresses the image data based on the compression ratio flag CRF.

The image processing device 300 in FIG. 3 differs from the image processing device 100 in FIG. 1 in that display driver 330 does not include a separate compression ratio detection unit. In the embodiment of FIG. 3, the compression ratio flag CRF generated from the compression ratio selection unit 315 is transmitted directly to the decoder 337. Also, in the embodiment of FIG. 3, the compression ratio flag CRF is illustrated such that it is transmitted to the display driver 330 while being separated from the compressed image data ED (but this is only illustrative), so the compression ratio flag may be included in the compressed image data ED and transmitted to the display driver 330. In this case, the decoder 337 decodes the compression ratio flag in the compressed image data ED and decompresses the compressed image data ED based on the corresponding compression ratio.

The decompressed image data ID2 may be the same as the image data ID1 received by the application processor 310. In this case, the encoder 311 may have performed lossless compression to generate the compressed image data ED. Alternatively, the decompressed image data ID2 may be different from the image data ID1 received by the application processor 310. In this case, the encoder 311 may have performed lossy compression to generate the compressed image data ED.

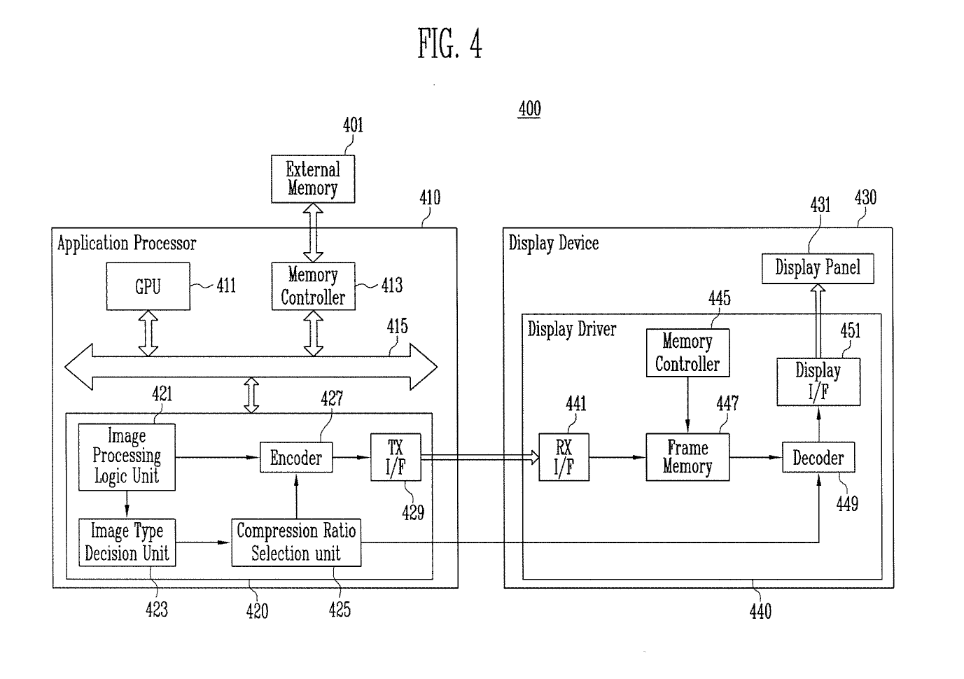

FIG. 4 illustrates another embodiment of a image processing device 400 which includes an external memory 401, an application processor 410, and a display device 430. In addition, the display device 430 may include a display panel 431 and a display driver 440.

The application processor 410 may include a graphics processing unit (GPU, 411), a memory controller 413, and a display controller 420 that can communicate each other via a bus 415. The display controller 420 may include an image processing logic unit 421, an encoder 427, an image type decision unit 423, a compression ratio selection unit 425, and a Tx interface 429.

The display driver 440 includes a Rx interface 441, a decoder 449, a memory controller 445, a frame memory 447, and a display interface 451. The Rx interface 441 may be implemented as the same as the Tx interface 429.

The image processing device 400 in FIG. 4 differs from the image processing device 200 in FIG. 2 in that the display driver 440 does not include a separate compression ratio detection unit. In the exemplary embodiment in FIG. 3, the compression ratio flag generated from the compression ratio selection unit 425 is transmitted directly to the decoder 449. The compression ratio flag may be transmitted to the display driver 449 while not being included in the compressed image data.

In one embodiment, the compression ratio flag may be transmitted to the display driver 440 while being included in the compressed image data. In this case, the decoder 449 may decode the compression ratio flag in the compressed image data and may decompress the compressed image data based on the corresponding compression ratio.

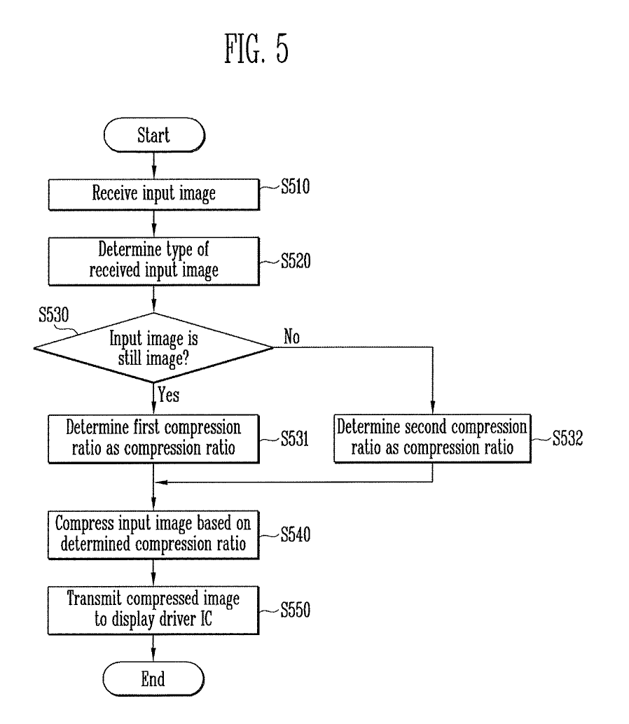

FIG. 5 illustrates an embodiment of a method for compressing an input image. In this embodiment, the input image is received (S510), a type of the input image is determined (S520), and determination of whether the input image is a still image or not is performed (S530). When the input image is a still image, a first compression ratio is determined as the compression ratio of the input image (S531). When the input image is a motion picture, a second compression ratio is determined as the compression ratio of the input image (S532). In one exemplary embodiment, the first compression ratio may be a lower than the second compression ratio. After the compression ratio of the input image is determined, the input image is compressed based on the determined compression ratio (S540) and transmitted to the display driver IC (S550).

The aforementioned method may be performed, for example, by the application processors 110, 210, 310, and 410 in FIGS. 1 to 4. Also, a relatively high compression ratio may be applied when the input image is a motion picture and a relatively low compression ratio may be applied when the input image is a still image, to thereby compress the image.

When the input image is a motion picture, it may be difficult to relatively recognize image loss compared with a still image even, when the image is compressed at a relatively high compression ratio. When a high compression ratio is used, the size of the compressed image data is reduced. Accordingly, when the compressed image data is transmitted from the application processor to the display driver IC, a less transmission bandwidth is used. In addition, compared with a case in which a motion picture is compressed and displayed at a low compression ratio, power loss of the driver IC may be reduced.

Since the image displayed on the screen does not change when the input image is a still image screen, it is easy to recognize compression loss when the image is compressed at a high compression ratio. According to one embodiment, image quality degradation recognized by a user may be reduced or minimized since the image is compressed at a low compression ratio for a still image.

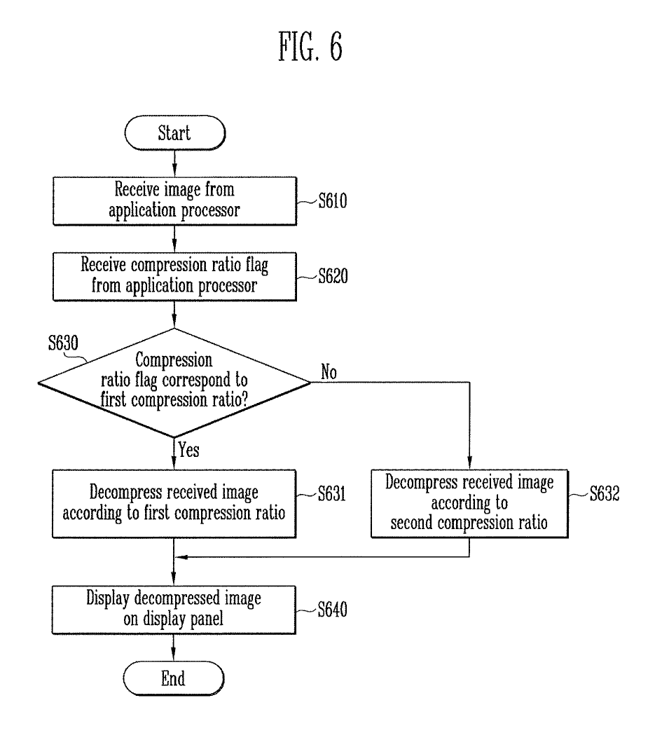

FIG. 6 illustrates an embodiment of a method for displaying an image on a display panel by decompressing the compressed image. Referring to FIG. 6, the method includes receiving image data from an application processor (S610) and receiving compression ratio flag from the application processor (S620). The image data may be compressed by the application processor. In addition, the compression ratio flag may be received while being separated from the image data, but may be received together with the image data while being included in the image data.

Next, whether the compression ratio flag corresponds to a first compression ratio is determined (S630). When the compression ratio flag corresponds to the first compression ratio, the received image data may be decompressed according to the first compression ratio (S631). When the compression ratio flag corresponds to a second compression ratio, the received image data may be decompressed according to the second compression ratio (S632).

Referring to FIG. 5, the image is compressed according to the first compression ratio when it is a still image and is compressed according to the second compression ratio when it is a motion picture. Accordingly, when the compression ratio flag corresponds to the first compression ratio, the received image data is a still image, so the image data may be decompressed based on a relatively low compression ratio. When the compression ratio flag corresponds to the second compression ratio, the received image data is a motion picture, so the image data may be decompressed based on a relatively high compression ratio.

After the received image data is decompressed, the decompressed image is displayed on the display panel (S640). The aforementioned operations may be performed, for example, by the display devices 230 and 430 in FIGS. 2 and 4. For example, operations S610, S620, S630, S631, and S632 may be performed by the display drivers 240 and 440 in FIGS. 2 and 4, and operations S640 to S632 may be performed by the display panels 231 and 431 in FIGS. 2 and 4.

In one embodiment, one or more operations of the method may be executed by computer program instructions. These computer program instructions may be performed by processors of a general-purpose computer, a special-purpose computer, or other programmable data processing equipment. The instructions executed by the processors of the computer or other programmable data processing equipment generates performs the operations of the method.

The computer program instructions may be executed by a computer or other programmable data processing equipment-oriented computer, and/or may be stored in a computer readable memory to implement the operations of the method in specific ways. The computer program instructions may be installed on a computer or other programmable data processing equipment.

In addition, each block may represent part of a module, segment, or code of one or more executable instructions for executing the specific logic function(s). In some exemplary embodiments, it should be noted that the functions indicated by the blocks may not be executed out of sequence described above. For example, two blocks sequentially illustrated may be substantially simultaneously executed or the blocks may be executed in reverse order in accordance with the corresponding functions.

In this case, the term ‘unit’ may represent software or hardware such as FPGA or ASIC, and the ‘units’ may perform certain roles. However, ‘unit’ is not limited to software or hardware, but may correspond to a storage medium that may be addressed and may be configured to operate one or more processors. Accordingly, as an example, ‘unit’ includes components such as software components, object-oriented software components, class components, and task components, processes, functions, attributes, procedures, subroutines, segments of program codes, drivers, firmware, microcode, circuit, data, database, data structures, tables, arrays, and variables. The functions provided by the components and ‘units’ may be combined by a smaller number of components and ‘units’, or may be further divided into additional components and ‘units’. In addition, the components and ‘units’ may be implemented to operate one or more CPUs in the device or the security multimedia card.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods herein.

The controllers, selection units, decision units, detection units, and other processing features of the disclosed embodiments may be implemented in logic which, for example, may include hardware, software, or both. When implemented at least partially in hardware, the controllers, selection units, decision units, detection units, and other processing features may be, for example, any one of a variety of integrated circuits including but not limited to an application-specific integrated circuit, a field-programmable gate array, a combination of logic gates, a system-on-chip, a microprocessor, or another type of processing or control circuit.

By way of summation and review, an application processor determines whether image compression will be performed when the processor transmits the image to display driver IC (DDIC). The application processor also transmits a flag denoting whether the transmitted image has been compressed or not. The DDIC performs image compression if the transmitted image has not been compressed and does not perform image compression if the transmitted image has been compressed. The application processor applies sole compression ratio when the image is compressed.

In accordance with one or more of the aforementioned embodiments, an image processing device may apply different compression ratio to an image encoder. For example, if input image is video (e.g., moving images), the image processing device may select high compression ratio of the image encoder since the user may not recognize deterioration of the image quality of video. On the other hand, the image processing device may select low compression ration if input image is stopped image, since the user may recognize deterioration of the image quality of stopped image. In the embodiments described herein, the image types have been described as motion picture and still image types. In another embodiment, the image types may be different.

When implemented in at least partially in software, the controllers, selection units, decision units, detection units, and other processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the embodiments set forth in the claims.

What is claimed is:

1. An image processing device, comprising:
a determiner to determine a type of an image;
a selector to determine a compression ratio based on the image type; and
a compressor to compress the image based on the compression ratio.

2. The device as claimed in claim 1, wherein:
the image type is a motion picture or a still image, and
the determiner analyzes the image to determine whether the image is a motion picture or a still image.

3. The device as claimed in claim 2, wherein:
the selector is to determine a first compression ratio as a compression ratio of the image when the image type is a motion picture and to determine a second compression ratio different from the first compression ratio as a compression ratio of the image when the image is a still image.

4. The device as claimed in claim 3, wherein the first compression ratio is greater than the second compression ratio.

5. The device as claimed in claim 3, wherein the determiner is to:
calculate a total sum of pixel data in the image, and
compare a result of the calculation with a total sum of pixel data in a previous image, determines the image as a motion picture if a difference between the total sum of the pixel data in the image and the total sum of the pixel data in the previous image exceeds a predetermined first threshold value, and
determine the image as a still image when a difference between the total sum of the pixel data in the image and the total sum of the pixel data in the previous image is less than the first threshold value.

6. The device as claimed in claim 1, wherein the selector is to generate a compression ratio flag indicating the determined compression ratio and is to transmit the compression ratio flag to a display device.

7. The device as claimed in claim 6, wherein the compression ratio flag is to be transmitted to a decompressor of a display driver.

8. The device as claimed in claim 3, wherein the determiner is to:
count a number of pixels in which data values are different by comparing the pixel data of the pixels in the image with the pixel data of corresponding pixels in a previous image,
determine the image as a motion picture when the number of pixels where the data values are different exceeds a predetermined second threshold value, and
determine the image as a still image when the number of pixels where the data values are different is less than the second threshold value.

9. The device as claimed in claim 3, wherein the determiner is to:
sample one or more pixels of the image,
calculate a total sum of pixel data of the one or more sampled pixels,
compare the total sum of the pixel data of the one or more sampled pixels with a total sum of pixel data of one or more corresponding pixels in a previous image,
determine the image as a motion picture when a difference between the total sum of the pixel data of the one or more sampled pixels and the total sum of the pixel data of the one or more corresponding pixels in the previous image exceeds a predetermined third threshold value, and
determines the image as a still image when a difference between the total sum of the pixel data of the one or more sampled pixels and the total sum of the pixel data of the one or more corresponding pixels in the previous image is less than the third threshold value.

10. The device as claimed in claim 3, wherein the determiner is to:
count a number of vertical synchronization signals VSYNC for a time,
determine the image as a motion picture when the counted number exceeds a predetermined fourth threshold value, and
determine the image as a still image when the counted number is less than the fourth threshold value.

11. An image processing device, comprising:
an application processor to determine a compression ratio of an image according to a type of the image and to compress the image based on the compression ratio; and
a display device to receive the compressed image and decompress the compressed image based on the compression ratio.

12. The device as claimed in claim 11, wherein the application processor includes:
a determiner to determine a type of an image;
a selector to determine a compression ratio of the image according to the image type; and
a compressor to compress the image based on the compression ratio,
wherein selector is to determine a first compression ratio as a compression ratio of the image when the image type is a motion picture and is to determine a second compression ratio different from the first compression ratio as a compression ratio of the image when the image is a still image.

13. The device as claimed in claim 12, wherein the display device includes:
a frame memory to store the compressed image; and
a decompressor to decompress the compressed image stored in the frame memory based on the compression ratio determined by the selector.

14. The device as claimed in claim 13, wherein the display device includes a display panel to display the decompressed image.

15. An image processing method, comprising:
receiving an image;
determining a type of the image;
determining a compression ratio based on the image type; and
compressing the image based on the compression ratio.

16. The method as claimed in claim 15, wherein:
the image type is one of a motion picture or a still image; and
determining the image type includes comparing the image with a previous image.

17. The method as claimed in claim 16, wherein determining the compression ratio includes determining the compression ratio as a first compression ratio when the image type is a motion picture and determining the compression ratio as a second compression ratio lower than the first compression ratio when the image type is a still image.

18. The method as claimed in claim 16, wherein determining the image type includes:
calculating a total sum of pixel data in the image;
comparing a total sum of the pixel data in a previous image with the total sum of the pixel data in the image; and
determining the image as a motion picture or a still image based on a result of the comparison.

19. The image processing method as claimed in claim 18, wherein determining the image type includes:
determining the image type as a motion picture when a difference between the total sum of the pixel data in the image and the total sum of the pixel data in the previous image exceeds a predetermined first threshold value, and
determining the image type as a still image when a difference between the total sum of the pixel data in the image and the total sum of the pixel data in the previous image is less than the first threshold value.
